(19) United States
(12) Patent Application Publication
(10) Pub. No.: US 2013/0304493 A1
(43) Pub. Date: Nov. 14, 2013

(54) DISEASE MANAGEMENT SYSTEM

(71) Applicant: Sanitas, Inc., La Jolla, CA (US)

(72) Inventor: Naser Partovi, La Jolla, CA (US)

(21) Appl. No.: 13/939,453

(22) Filed: Jul. 11, 2013

Related U.S. Application Data
(62) Division of application No. 13/304,180, filed on Nov. 23, 2011.
(60) Provisional application No. 61/416,578, filed on Nov. 23, 2010.
(60) Provisional application No. 61/439,480, filed on Feb. 4, 2011.

(51) Int. Cl. G06F 19/00

(52) U.S. Cl. CPC G06F 19/3418
USPC 705/2

(57) ABSTRACT

Disclosed herein are systems and methods for interactive guided personalized/personalizable patient disease management system. The system offers ongoing personalized education in response to user inputs which may include a patient's electronic health record, diagnostic codes, billing codes, and/or medical history, the ability to monitor a patient's progress throughout their treatment plan which is initially provided by the system and a patient support community for boosting patient treatment plan compliance through ongoing monitoring and personal coaching. The systems and methods provide personalized relevant diagnostic, prognostic, prevention and/or treatment information output which are curated to manage the patient's needs.

### CROSS-REFERENCE TO RELATED APPLICATIONS

This application is a divisional application of and claims priority benefit under 35 U.S.C. §120 from U.S. application Ser. No. 13/304,180, filed Nov. 23, 2011, entitled “DISEASE MANAGEMENT SYSTEM USING PERSONALIZED EDUCATION, PATIENT SUPPORT COMMUNITY AND TELEMONITORING,” which is hereby incorporated by reference in its entirety, and which claims priority benefit under 35 U.S.C. §119(e) from each of the following m U.S. Provisional Patent Applications, each of which is hereby incorporated by reference in its entirety:
U.S. Provisional Patent Application No. 61/416,578, entitled “INTERACTIVE GUIDED PERSONALIZED EDUCATION SYSTEM AND METHOD OF USE,” filed Nov. 23, 2010; and
U.S. Provisional Patent Application No. 61/439,480, entitled “PATIENT MANAGEMENT SYSTEM USING PERSONALIZED EDUCATION AND PATIENT SUPPORT COMMUNITY,” filed Feb. 4, 2011.
   Any and all priority claims identified in the Application Data Sheet, or any correction thereto, are hereby incorporated by reference under 37 C.F.R. §1.57.

### BACKGROUND

1. Field

Embodiments relate to disease management systems and, more specifically, to a customizable disease management system which may include a personalized patient support community as well as treatment plan and medical information databases and telemonitoring. The system may generate personalized patient information and may also be used as part of a disease management system, which may include patient discharge management functions. Some embodiments of the system leverage treatment plans and personalized education linked to patient diagnoses and medical history, as well as support through the personalized patient support community, to increase the quality of patient care. The disclosure also pertains to methods by which such systems may be configured to operate.

2. Background

Informed patients report increased levels of satisfaction from their healthcare providers and are significantly more compliant with their treatment plans than are uniformed patients. This ultimately results in better outcomes for the patient, including lower readmission rates to hospitals. Informed and satisfied patients are also much less likely to pursue costly litigation against their providers largely due to the fact that their decisions better reflect their personal preferences, values and concerns. In addition, several readily available studies show that there are major costs placed upon the healthcare system due to patient non-compliance with their treatment plans. Some studies put the cost of non-compliance to medication alone at near $200 billion per year to U.S. healthcare system. Over 20% of congestive heart failure patients released from a hospital are readmitted due to non-compliance with a treatment plan, amongst other reasons. This leads those patients back to the hospital at a large cost per patient that may be borne by health care payers.

Studies show that one of the most effective tools for behavior change is “peer support”. In this context, patient behavior change potentially through appropriate and guided peer pressure and personal coaching could result in better compliance with a treatment plan(s). Other studies link positive motivation to better compliance with treatment plans.

### SUMMARY

A leading author has recently shown that the three drivers of motivation are: autonomy, mastery, and purpose (Pink 2009). The personalized disease management system described herein provides tools and techniques for helping patients with treatment plan compliance through a support community which may include all three of these drivers of motivation, as well as personal coaching. These tools and techniques enable a patient to take control of their treatment (“autonomy”), help them achieve “mastery” through a personalized, guided education system and patient support community, and finally help with “purpose” through monitoring patient's progress towards their goals and supporting them to achieve those goals.

Thus, embodiments of the invention include methods and systems for providing improved personalizable patient management and education that motivates patients to comply with their treatment plans. This results in better clinical outcomes including significant reductions in healthcare costs via mitigation of patient non-compliance, readmissions and litigation, amongst other factors. The system described herein is especially suitable for patients with chronic diseases/conditions and may be provided through an easily navigable web-based interface. In addition, embodiments of the system are configured to collect patient information across a patient population, thus serving as a resource to gain new insight into patient compliance as well as unknown factors or aspects related to specific treatment plans as well as clinical trials.

Various embodiments provide a novel configuration of system components capable of providing a customizable or personalizable disease management system that allows subscribing healthcare institutions and other healthcare providers to extend individualized care to their patients while keeping the communication loop between the patient, physician and administrators intact.

Disclosed herein are systems and methods that provide an interactive guided personalized disease management system. One embodiment of the system offers ongoing personalized education in response to user inputs which may include a patient's electronic health record, diagnostic codes and/or billing codes. In addition, the system may have the ability to monitor a patient's progress throughout their treatment plan. This monitoring can be supplied by the system itself, but also in conjunction with a patient support community for boosting patient treatment plan compliance through ongoing monitoring and personal coaching. Monitoring can also be facilitated by medical devices and smartphone. The systems and methods provide personalized relevant diagnostic and/or treatment information data which are curated to manage the patient's needs. The systems may include decision trees, treatment plan and medical information databases, user and third party input interfaces, support communities, and patient electronic health records.

The ability of the system to combine ongoing education, monitoring and feedback as supported by a patient support community provides a comprehensive and unique product for addressing a patient's needs throughout a treatment plan. This can ultimately result in better clinical outcomes for the patient using the system. In one embodiment, the system and method can be used as part of an outpatient management program. The disease management system by design motivates patients during their ongoing treatment plans to ultimately improve treatment plan compliance and thereby reducing healthcare related costs. The system may also be configured to collect patient information across a patient population thus serving as a resource to gain new insight into patient compliance as well as unknown factors or aspects related to specific treatment plans.

In one innovative aspect, a system for providing medical information for a specified condition is provided. The system includes a patient database comprising information indicating a condition suffered by the patient and condition dates that indicate how long the patient has had the condition. The system further includes a condition module configured to determine one or more conditions suffered by the patient by analysis of the condition codes. The system also includes an education module configured to perform searches on the determined conditions and provide medical information that is appropriate for the patient depending on how long the patient has had the condition.

In another innovative aspect, a system for allowing secure messaging between patients and care team members responsible for the medical care of a patient is provided. The system includes a patient table comprising a plurality of patient records. The system also includes a care team table comprising a plurality of care team records. The system includes a relationship management module comprising instructions for matching patient records with care team records to form a relationship. The system further includes a secure messaging module configured to allow encrypted messages to flow to and from patients that have a relationship with and care team members.

In a further innovative aspect, an on-line patient monitoring system is provided. The system includes a first display page configured to display patient health data. The system also includes an input field configured to receive updated medical data from the patient. The system further includes a relationship module configured to maintain relationships between the patient, a medical team, and a patient support community. The system also includes a messaging module configured to read the updated medical data send a message to the medical team or the patient support community if the updated medical data meets predetermined criteria.

The systems, methods, and devices described herein each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features discussed provide advantages that include secure personalized patient care management.

### BRIEF DESCRIPTION OF THE DRAWINGS

For a more complete understanding of the present disclosure, the objects and advantages thereof, reference is now made to the ensuing descriptions taken in connection with the accompanying drawings briefly described as follows.

FIG. 1 shows an interaction diagram for a disease management system in accordance with an embodiment of the disclosure.

FIG. 2 shows a functional block diagram of a health care server in accordance with an embodiment of the disclosure.

FIG. 3 shows a functional block diagram of an embodiment of a disease management system.

FIG. 4 shows a medical information data visualization of a disease management system information database in accordance with an embodiment of the disclosure.

FIG. 5 shows a patient support community dashboard of a disease management system in accordance with an embodiment of the disclosure.

FIG. 6 shows a process flow diagram for a method of using the disease management system.

FIG. 7 shows a diagnostic flow diagram of a disease management system database in accordance with an embodiment of the disclosure.

FIG. 8 shows a treatment plan flow diagram of a treatment plan that may be included in a disease management system in accordance with an embodiment of the disclosure.

FIG. 9 is a network diagram which shows an embodiment of a personalized disease management system interfacing with a hospital IT system.

FIG. 10 is a network diagram which shows another embodiment of a personalized disease management system interfacing with a hospital IT system.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Personalization on Multiple Dimensions

One embodiment is a system and method that provides personalized medicine to a patient on multiple dimensions. One dimension focuses on the doctor and what the doctor decides that the patient should monitor on a daily basis. Thus, the system allows a physician to enter separate, specific treatment plans for each patient and then have the system monitor those plans to ensure that each patient is on a plan to become healthy. The physician can also setup specific medical parameters within the system to be provided each day by the patient, such as blood pressure, weight, and medical administration. A second dimension of the system is the tailored curriculum of education for the patient that provides specific, timely, pertinent information to help the patient understand the scope of the disease and the treatment options to empower the patient to make the right treatment choices. A third dimension is the creation of a patient-support-community using the system. In addition to linking a patient's family and friends together into an easy-to-manage social network, the system also matches the patient with peer-patients that have similar diagnoses and treatment plans. Also linked into the patient support community is the patient's entire medical team, including physicians, nurses, assistants and ancillary care providers. For example if the patient has heart failure and diabetes, the system can identify and add a cardiologist, primary care providers, and an endocrinologist to the medical team to ensure that the patient-support community has connections to all the appropriate people to support the patient through their treatment plan. The fourth and final dimension is access to recent and pertinent news about their disease, along with access and information on clinical trials tailored to each patient based on their conditions, medical history and their diagnostic and treatment codes embodied in their electronic medical records. By providing this multi-dimensional approach to health care, the patient is supported and monitored by the system throughout their treatment plan to increase their odds of overcoming their disease.

### Education

One embodiment is a disease management system that provides personalized information to a patient. The information can be personalized so that it's specific for a particular patient and their indication. In one embodiment, a patient is diagnosed to have a particular indication. That indication is normally associated with a specific diagnostic code, such as an SNOMED, HL7 or ICD-9 code. As described below, the patient disease management system is configured to receive the diagnostic code for the patient and tailor educational and other information for that specific diagnosis. Thus, a patient suffering from heart disease may be linked to the specific type of heart disease, such as chronic systolic heart failure, which is associated with ICD-9 code 428.22. Through the use of pairing specific diagnostic codes, the patient may be presented with timely, relevant information for his or her specific indication, and not general information that may not be appropriate for their own particular indication.

In addition, the system has the capability to not only provide specific, tailored information on the indication that is associated with a particular diagnostic code, but can also provide tailored information on co-morbidities associated with the relevant diagnostic code. Thus, if diabetes is also associated with patients have been diagnosed with chronic systolic heart failure, the system will associate that data and provide the patient with not only targeted information for the heart failure, but also targeted information on the potential to develop or determine diabetes risks. The education system may also provide personalized education based on the treatment plan. For example, the system can provide detailed information about the medications prescribed to the patient or the various procedures and/or surgeries for that patient.

In another embodiment, the patient disease management system includes a timeline module configured to deliver relevant educational information to a patient based on the received diagnostic and/or treatment code. In one embodiment, the information is divided into relevance based on the disease stage of the patient. For example, if the patient disease management system determines from an uploaded patient record that the patient was recently diagnosed with chronic systolic heart failure, a timeline of information can be generated. The timeline would include relevant different information for the patient based on their stage of disease. For a patient in the first three months following diagnosis, the timeline may include new patient information such as prognosis, diet, medicines, etc. that would be of interest to a new patient. For patients that have been living with the indication for over one year, the timeline may present information on maintaining long term remission, exercise goals, and long-term care options.

In another embodiment, the disease management system includes spiritual and inspirational information along with the educational information. Course content and contact information appropriate to the patient's religious background may be integrated at the patient's request so that the educational modules include not only scientific information on their indication, but also spiritual and faith-based guidance to help them heal.

### Patient Monitoring

In another embodiment, the disease management system includes a monitoring system. The monitoring system allows the patient to use a device (e.g., computer, smartphone, tablet, PDA, monitoring device) to log into the system through the Internet and report on their progress. In addition, wireless reporting devices such as heart monitors integrate with the system to automatically update the patient's information into their patient record. In one embodiment, the system includes timers and flags associated with specific events that are to be monitored. For example, in one embodiment, the system requires the patient to enter their weight and blood pressure every three days. If the system detects that the patient has not entered this data within the prescribed time period, a warning text or email can be sent to the patient. In addition, the system can be configured to send warning texts or emails to members of the patient's linked social group. Thus, a doctor, relative, or caregiver can be notified if the patient being monitored does not fulfill the requirements of the monitoring program. This allows members of the patient's social network to help the patient stay on track with their healing process.

In addition, the monitoring system may include native logic that warns a caregiver if the patient is not improving along a predetermined timeline. For example, the system may store and track the patient's blood pressure following a new prescription for a blood pressure lowering drug such as Altace®. If instructions within the system do not find that the patient's recorded blood pressure has been lowered within 30 days a warning text, email or call can be placed to the physician to notify them that the medicine may not be working properly. This patient compliance and health data can be uploaded from the disease management system to the hospital's medical record system for further analysis and storage.

Thus, the monitoring system allows the health care provider, such as the physician or nurse or a case manager and the support community of family, friends, peer-patients to motivate and help the patient stay on track with their treatment plan. As part of that, the system provides the medical team with an ability to instantly view the full daily medical history of the patient. The medical team can also communicate securely with the patient via the same messaging system. In addition, the medical team can communicate with other members of the medical team using the same encrypted private messaging, with or without including the patient and his/her support community in those communications. The system provides selections that allow the doctor to select what symptoms they want to monitor and set threshold for each of symptoms/signs outside which they will be alerted. Additionally, the medical team is provided with the ability to view the patient's tailored educational material and to highlight articles that they would like their patients to read. These highlighted articles are then flagged within the system to be presented to the patient as part of the educational module discussed above. This can be used, for example, by the medical team to educate a patient on smoking cessation techniques. By flagging the proper educational material for the patient, they can point the patient to the right article in their curriculum and still qualify for “meaningful use” funds from the government. The system also allows the medical team to view all of a patient's medical records, not just their own portion by consolidating all information from all providers into one central database that can be used by all of the medical care team.

The system also gives similar monitoring capabilities to authorized members of the patient's support community. Thus, the support community is given the ability to view the patient's daily medical history, patient's appointment calendar and daily monitoring requirements. Of course, the patient controls access of the support community members so that the privacy of the patient is protected at all times. By setting privacy settings, the patient can grant access to more or less data on their condition or treatment for any support community member. In addition, the support community is able to provide ongoing direct support and advice to the patient using the same messaging system as used by the medical team to communicate with the patient. Support community members can also be granted the ability to view the patient's educational material and learn about the patient's condition, diagnosis and treatment options.

### Social Networking

In another embodiment, the system uses the diagnostic and/or billing codes uploaded from the patient's health record to build a common social network with patients having similar indications. Thus, the patient may request to be linked to any other patient that has chronic systolic heart failure instead of the entire group of patients with heart disease. This allows each patient to tailor their social network to having the most relevant members to help them have the most support and information for their indication. Thus, in one embodiment, the patient can nominate family, friends, and spiritual leaders to be within their social network. In addition they can request to be paired with patients suffering from the same indication, as associated using diagnostic codes. Once another patient suffering from the same indication gives permission, the two patients will be linked together within the social network so that they can support each other through their medical treatment. The social network can also include ancillary care workers and other providers.

### Rewards System

Another embodiment is a system that provides rewards and incentives to a patient for attaining certain goals, or completing certain tasks monitored by the system. For example, the system can assign and track points that are used to reward patients for utilizing the system to manage their medical care. For example, the system may track and assign points to the patient for entering monitoring data, reading education modules, and/or communicating with support community members. After a predetermined number of points have been accrued, the system allows the patient to redeem points that can be in the form of vouchers, coupons, cash, health care services, or other goods and services that are attractive to the patient.

### Integrated Functionality

Although described as separate aspects, one or more of the personalization, education, patient monitoring, social networking, and rewards system may be integrated to provide disease management. For example, the education feature may be combined with the social networking to educate support community in patient's diagnosis to increase their engagement level and ability to support the patient. In one implementation, the support team becomes a source of education material. For example, a nutritionist may post low salt diet recipes or peer patients may share practical advice learned through experience.

Social networking features may be combined with patient monitoring features. In some implementations, monitoring alerts and congratulatory messages may be routed to the support team as part of a feedback loop. This allows the support team to become part of the monitoring system (i.e., a human component to accompany self-reporting from the patient and data from telemonitoring devices). The support team may monitor the site and gauge real-life interactions with the patient to better inform the care team how the patient is doing. This communication may be performed within the provided privacy framework described below.

Patient monitoring features may be combined with educational features. Education may be tailored (i.e. adapted) to ongoing monitoring input. For example, tips on maintaining a low salt diet may be presented if a patient reports increased swelling. Such a combination may also provide the ability to monitor a patient's progress as they are provided with an education curriculum. By further including social networking features, the patient, and their support community, may be educated on what is being monitored and why. The support team may access the system to guide a patient through the process. If there is a break in the system (e.g., treatment missed, reading missed, appointment missed, vital sign changes), the information may cycle back through the feedback loop.

### System Overview

As used herein, an input device can be, for example, a keyboard, rollerball, mouse, voice recognition system or other device capable of transmitting information from a user to a computer. The input device can also be a touch screen on a wireless telephone, computer or tablet device in which case the user responds to prompts on the display by touching the screen. The user may enter textual information through the input device such as the keyboard or using a virtual keyboard on the touch-screen.

The disclosure is operational with numerous other general purpose or special purpose computing system environments or configurations. Examples of well known computing systems, environments and configurations that may be suitable for use include personal computers, server computers, hand-held, tablet or laptop devices, medical devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN) or Wide Area Network (WAN) may be a corporate computing network, including access to the Internet, to which computers and computing devices making up the system are connected. In one embodiment, the LAN conforms to the Transmission Control Protocol/Internet Protocol (TCP/IP) industry standard.

As used herein, media refers to images, sounds, video or any other multimedia type data that is entered into the system.

A microprocessor may be any conventional general purpose single-core or multi-core microprocessor such as a Pentium® processor, a Pentium® Pro processor, ARM®, MIPS®, Power PC®, or ALPHA® processor. In addition, the microprocessor may be any conventional special purpose microprocessor such as a digital signal processor or a graphics processor.

The system includes various modules as discussed in detail below. As can be appreciated by one of ordinary skill in the art, each of the modules may include various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as APPLE LION, LINUX, UNIX or MICROSOFT WINDOWS®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code.

A web browser comprising a web browser user interface may be used to display information (such as textual and graphical information) to a user. The web browser may include any type of visual display capable of displaying information received via a network. Examples of web browsers include Google Chrome, Microsoft's Internet Explorer browser, Mozilla's Firefox browser, Apple's Safari browser, or any other browsing or application software capable of communicating with a network.

The concepts disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

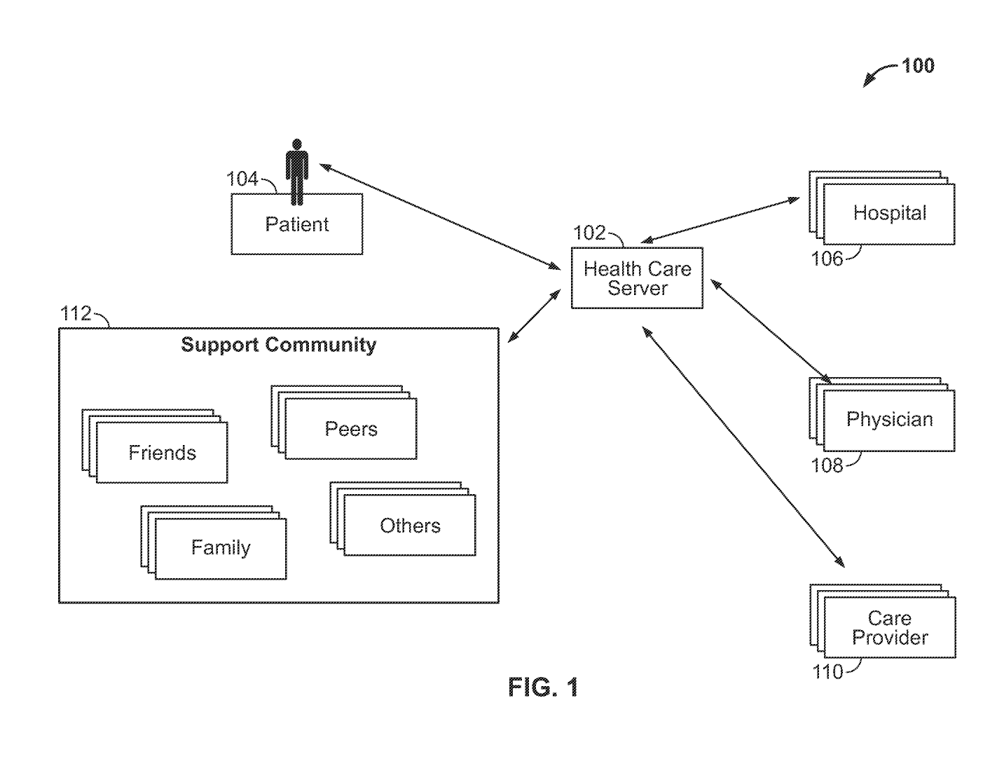

FIG. 1 shows an interaction diagram for a disease management system 100 in accordance with an embodiment of the disclosure. The patient disease management system 100 includes a patient health care server 102. The health care server 102 serves as a hub for the patient disease management system 100. The health care server 102 may include one or more specialized computing devices to support the functionality described in further detail below. The computing devices may be optimized to perform the specific tasks related to patient management. The components of the health care server 102 may be centrally located, such as in networked server room. In some embodiments, the components of the health care server 102 are distributed. In other embodiments, the components are virtual components, hosted on devices that may be configured to perform the specific functions described in detail below.

One or more patient systems 104 can connect and be used by patients to enroll with the disease management system 100. Enrollment may be completed, for example, through an online interface provided by the health care server 102. In some implementations, a patient system 104 may be used to enroll through a machine interface, such as a web-service, by another actor of the disease management system 100. The patient system 104 may access the health care server 102 to receive health information, input health data, and manage other aspects of their wellness program. The patient system 104 may access the health care server 102 via a networked device such as a laptop computer, smartphone, tablet computer, or desktop computer.

The patient system 104 may be associated with one or more hospitals 106. For example, if the patient was recently discharged from a hospital 106, the hospital 106 may have medical treatment information that can be used to tailor the patient's discharge treatment program. This information may include continuity of care information, specific instructions or steps to be performed by the patient, and the like. In addition, the hospital may have medical records and treatment code information that may be imported into the health care server 102 as described in more detail below.

The patient may be under the care of one or more doctors that have physician systems 108. The physician system 108 may be connected directly to the hospital 106, through the Internet, or through the health care server 102. The physician may be the patient's regular physician (e.g., primary care physician). The physician may be a specialist who attended to the patient. The physician may be a specialist who has not seen the patient, but may provide insights on the patient and their condition by accessing the disease management system 100. The physician system 108 may be used by the physician to access the health care server 102 to communicate with or about a patient. The physician system 108 may access the health care server 102 to manage wellness programs for one or more of their patients. As with the patient system 104, the physician system 108 may access the health care server 102 using a networked device.

Similarly, the patient may be under the care of one or more care providers that link to the health care system 102 through one or more care provider systems 110. A care provider may include service providers such as a nurse, a nurse practitioner, a physical therapist, a massage therapist, a nutritionist, and the like. The care provider system 110 may access the patient health server 102 directly, or through a link to the Internet, in a similar manner as described above for a physician system 108.

The disease management system 100 may also include a support community 112 for the patient. The support community 112 may include friends, family members, peers (e.g., other patients), school teachers, and other individuals who may provide assistance to the patient during their treatment program. The peers may be suggested to the patient based on similar indications. For example, the patient management system 100 may identify other patients enrolled in the disease management system 100 having a similar age and indication as another user.

The support community 112 includes systems from the friends, peers, family or others that are used to enroll using similar interfaces as described above. In some implementations, the patient system 104 may generate invitations to entities identified by the patient as potential members of their support community. An invitation may be a uniquely identifiable code that the entity may use to access the system. When the system receives the code, it may be used to identify the patient who caused the invitation to be generated. Thus, the link between a patient and a support entity may be established.

The patient may also use the patient system 104 to control the level of access for members of the support community 112. The support community 112 may access the system as described above using a networked device. The support community 112 may monitor and interact with the patient and other members of the support community, care providers, doctors, or the hospital (collectively referred to as the care team) via on-line connections to the patient health server 102. The types of interactions and the control thereof will be described further below.

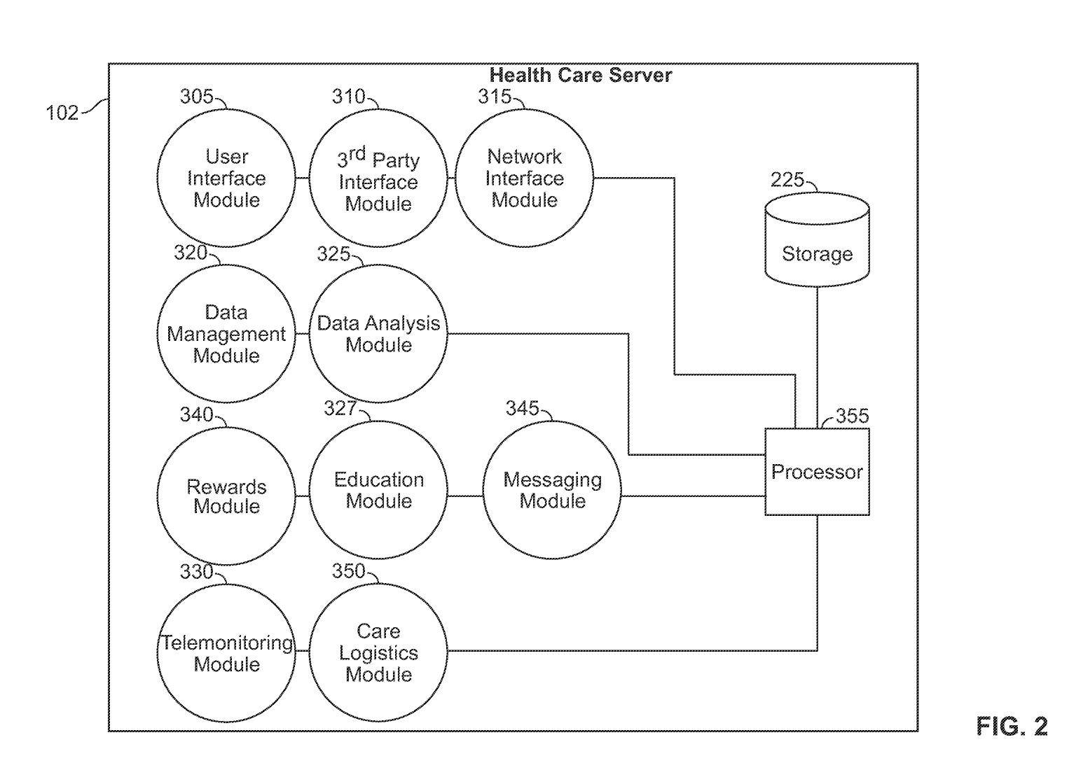

FIG. 2 shows a functional block diagram of the health care (HC) server 102 in accordance with an embodiment of the disclosure. As shown, the HC server 102 includes a user interface module 305, a third party interface module 310, a network interface module 315, a data management module 320, a data analysis module 325, a telemonitoring module 330, an education module 327, a rewards module 340, a messaging module 345, and a care logistics module 350. The HC server 102 shown also includes a processor 355.

The user interface module 305 is configured to have instructions that provide an interface for users of the disease management system as described herein. For example, the user interface module 305 may obtain information stored in the HC server 102 and generate one or more signals representing an interactive display, such as a web-page, including the information obtained. The user interface module 305 may also be configured to receive and process data from a device of a user. For example, the user interface module 305 may receive data indicating the patient's current weight which may be stored in association with the patient's health information in the storage coupled with the HC server 102. The user interface module 305 may also include a machine interface configured to produce a display representing the information according to a programming interface. The machine interface may accept information requests and respond using a machine readable format (e.g., XML). Examples of machine interface implementations include SOAP, REST, RMI, and the like.

The third party interface module 310 is configured to provide an interface for third parties such as medical professionals, service or other healthcare providers, a support network or community, or others as described herein. For example, the third party interface module 310 may obtain information stored in the HC server 102 and generate data to be displayed on an interactive display, such as a web-page, including the information obtained. The third party interface module 310 may also be configured to receive and process data from a device of a third party. For example, the third party interface module 310 may receive data indicating a patient's lab test result which may be stored in association with the patient's health information in the storage coupled with HC server 102. As with the user interface module 305, the third party interface module 310 may include a similarly configured machine interface.

The network interface module 315 may be configured to support sending and receiving information via the network as shown in FIG. 1. The user interface module 305 or the third party interface module 310 may be coupled with the network interface module 315 to assist in the transfer of information across the system 100.

The data management module 320 is configured to manage data received from the user and third parties and sent to the user and third parties as described herein. The user interface module 305 or the third party interface module 310 may be coupled with the data management module 320 to assist in the data storage. The data management module 320 may also be configured to manage non-patient specific information such as HC server 102 content data. Content data may include informational articles and multimedia content. The data management module 320 may be configured to store data, associate data with an actor of the system, secure the data (e.g., encryption, access, authentication), categorize the data, and the like. For instance, in one implementation, patient records may be stored in a patient table of a database. In some implementations, a care team table of a database may store care team records. The data management module 320 may also be coupled with a relationship management module. The relationship management module may be configured to match patient with care team records to form a relationship. The relationship management module may be further configured to enforce the access permissions set for members of a patient's care team.

The data analysis module 325 is configured to analyze data as described herein. For example, the data analysis module 325 is configured to implement by a processor the personalized treatment plans which may include decision trees as described. The data analysis module 325 may be coupled with the data management module 320 to provide secure access to the HC server 102 data. The data analysis module 325 may also be coupled with the user interface module 305 and/or the third party interface module 310 to provide data analysis to users or third parties. In some implementations, the data analysis module may include a condition module configured to determine one or more conditions suffered by the patient by analysis of one or more condition codes associated with a patient. A condition code may indicate a condition suffered by the patient. The condition codes may also indicate particular services administered to a patient, a service venue, or billing information for the service. The condition codes may be based on a standard condition code listing stored in a memory associated with the health care system.

In some implementations, the data analysis module 325 may include a peer matching module. The peer matching module may be configured to identify users of the system having certain characteristics in common. By allowing users suffering from the same indication to connect, improved health outcomes may be achieved. The peer matching module may be configured to match patients by condition codes. The peer matching module may further refine the matching by also considering additional patient information such as age, location, hospital, doctor, common support community relationships (e.g., similar pastor, friend, therapist). The identified peers may be invited to join the patient's support community as described above.

The telemonitoring module 330 may be configured to allow remote monitoring of a patient. The telemonitoring module 330 may be configured to receive or send data, such as via the network interface module 315, from or to monitoring devices such as a glucose monitor, blood pressure monitor, scale, thermometer, heart rate monitor, video capture, audio capture, and other devices configured to collect information about the patient. The telemonitoring module 330 may be configured to store the received data, for example via the data management module 320. The telemonitoring module 330 may be configured to display the data, for example via the user interface module 305 and/or the third party interface module 310. Televisits (e.g,. televideo conferences with physicians, care team members, support group) may be facilitated by the telemonitoring module.

The education module 327 may be configured to implement personalized and timely patient education, which may include nominating and providing educational modules that may include latest news and clinical trials targeted to a patient's specific condition. For instance, in some implementations, the education module may be configured to perform searches on the determined conditions and provide medical information that is appropriate for the patient depending on how long the patient has had the condition. The education module 327 may be configured to work in conjunction with the data analysis module 325 to identify and personalize content. The education module 327 may further consider input from uses of the system to personalize the educational items and the order of presentation of the items. For example, a video about exercise and a video about diet may be identified for two patients. The doctor may determine that for the first patient diet is of a higher concern and accordingly may move this content to the top of the first patient's list. This personalized education may complement direct guidance provided throughout a patient's treatment plan from providers, experiential knowledge and/or spiritual guidance provided by a patient support community. The education module 327 may be further configured to allow doctors to submit educational materials on a particular condition or subject, such as a wiki described below.

In some implementations, the education module may be coupled with a current events module. A current events module may be configured to search for current events that may be of interest to a patient. For instance, based on an indication for the patient as manifested through a condition code, the patient may want to learn about a healthy eating seminar in their area. Current events may be entered into the disease management system 100 and categorized with related condition codes. When a user accesses the system, the current event module may search for current events for the user. The current event may include a news item (e.g., article in a medical journal, legislation, video segments, FDA announcements) or a clinical trial for a treatment related to a condition of the patient.

The rewards module 340 may be configured to provide and track reward offers for patients and other actors of the system as described in further detail below. For example, the rewards module 340 may offer a coupon to a fitness club to a patient for entering health information for a number of consecutive days. The rewards module 340 may be further configured to allow redemption of a reward, such as accepting a signal indicating eligibility for a reward and causing the reward to be presented. The rewards module 340 may be coupled with one or more modules such as the data management module 320, the data analysis module 325, the user interface module 305, or the network interface module 315.

In some implementations, the messaging module 345 may be configured to enable secure messages to be exchanged between actors. For example, the messaging module 345 may be configured to allow a doctor to send a message to a patient or a member of the patient's support community. The messaging module 345 may be configured to deliver and display the messages via the HC server 102. The messaging module 345 may be configured to deliver messages for display outside the HC server 102, such as via email, text message (e.g., SMS or MMS), video message, postal, or telephone. In some implementations, the messaging module 345 may transmit messages upon the occurrence of an event. For example, if the telemonitoring module 330 receives a high glucose reading for a patient, the messaging module 340 may be configured to transmit a message to the doctor and/or the patient's support community. The messaging module 345 may be coupled with one or more modules such as the data management module 320, the data analysis module 325, the user interface module 305, or the network interface module 315. The messaging module 345 may be configured to comply with one or more standard such as the Health Information Portability and Accountability Act (HIPAA). In some implementations, the messaging module 345 may include additional security features (e.g., one-way encryption of messages, two-way encryption of messages, password protected messaging). A messaging module 345 including one or more security features may be referred to as a secure messaging module.

The care logistics module 350 may be configured to coordinate the care for a patient. Such items to be coordinated include timing of events (e.g., appointments, medicine administration, exercise periods). The coordination may be amongst a patient and one or more member of the patient's support community. For example, if a patient needs to be transported to an appointment in the afternoon and has a scheduled dose of medicine, a care giver may be able to attend to these tasks at the same time, rather than dispatching two care givers. The care logistics module 350 may access schedule information for a doctor or hospital to assist in scheduling appointments. The care logistics module 350 may be configured to incorporate public and/or private transportation schedules to further assist in the coordination. The rewards care logistics module 350 may be coupled with one or more modules such as the data management module 320, the data analysis module 325, the user interface module 305, or the network interface module 315.

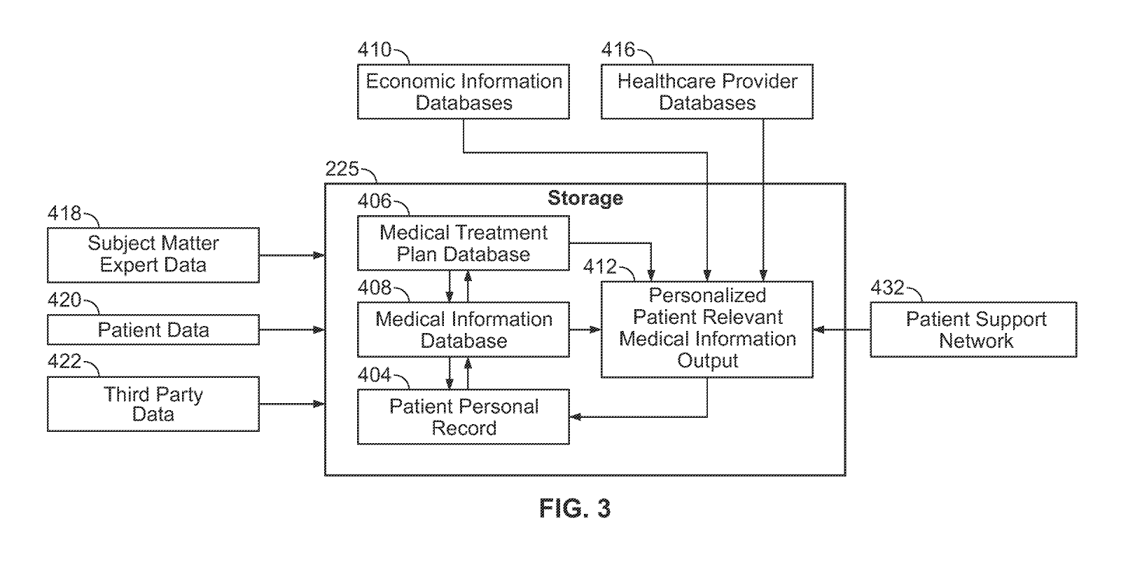

FIG. 3 shows a functional block diagram of data flow in one embodiment of the disease management system 100. In the system shown in FIG. 3, the arrows represent information flow. The depicted boxes represent distinct but not necessarily analogous elements (databases, curated information, healthcare providers) and the arrows connecting the boxes represent data/information flow. The system is a platform upon which its methods of use may be implemented. It will be appreciated that the system of FIG. 3 may be implemented using the systems described above with respect to FIGS. 1-3, as well as with the figures that follow.

A user of the patient disease management system enters patient relevant and/or related information via a user device using the input interface 402 provided by the user interface module 305. Alternatively, the user may upload or enter patient information through established electronic health record systems such as Microsoft HealthVault® and WebMD Health Manager®. Users may include third parties such as healthcare providers who may upload patient electronic health records or enter patients' information via a third party device 215 using the interface provided by the third party interface module 310. In some implementations, a patient may download their information from a hospital patient portal and upload it to the system. This information may include medical information such as current symptoms, medical history, and preferences and other information regarding the user including vital signs and biomarkers. This information may also include patient diagnostic codes (SNOMED, HL7, ICD9, ICD10, etc.) which may be extracted from an uploaded or entered electronic health record. These codes may be matched with educational modules designed to be delivered to the patient in a timely fashion similar to a course curriculum. This information may include patient treatment information such as patient medication, specific diets or exercises prescribed for the patient, any procedure or surgeries prescribed, and any diagnostic tests prescribed. This information may also include information coming from a medical device such as a glucose monitor, electronic blood pressure cuffs, wireless weight scales, continuous glucose monitors, cardiac telemetry devices, etc. which may be entered through the user or third party interface modules 305, 310 automatically and/or directly into any of the system databases. The information may be stored by the data management module 320 in a patient personal record 404 which may be an electronic health record. Note that the patient personal record 404 may be considered a database. The information may then be used by the analysis module 325 for analysis using medical treatment plans database 406 and potentially medical information database 408 as part of the personalized education, monitoring and treatment plan. In addition, the patient personal record 404 may contain information specific to the individual patient, unlike the medical treatment plans database 406 and the medical information database 408, which may also contain information not specific to the individual patient and instead information towards patient populations. Furthermore, individual patient personal records 404 may be aggregated, anonymized and studied for research and data mining, for example to provide insights with regard to compliance across patient populations as well as the effects of social networks on healthcare delivery.

Information may be collected by the databases in several ways. For example, users can input information directly. In addition, user input may be solicited based on initial input as determined by the data analysis module 325 using a decision tree or flow diagram based upon a treatment plan from the medical treatment plans database 406. Information can also be collected from the database 408. In an exemplary embodiment, the system is configured to collect and store patient information across a patient population thus serving as a resource to gain new insight into patient compliance as well as unknown factors or aspects related to specific treatment plans as well as clinical trials.

This multi-sourced curated information including individual patient specific information (e.g., a diagnostic code) and patient population information (e.g., an established medical treatment plan) may be combined with additional relevant economic information from economic information databases 410. This additional information can come from several different types of databases and sources, such as third parties using the third party interface module 310. In one embodiment, the data analysis module 325 is also configured to generate and output personalized patient relevant medical information output (PPRMIO) 412. Thus, by the time the user is provided with PPRMIO, information has been contributed from multiple sources to provide specific, curated, digestible, succinct, relevant information. These multiple sources of information may include: information initially entered by the user or a third party at user interface 402 provided by the interface modules 305 and 310. The information may come from the information database(s) 408 such as storage 225. Information may come from and/or be entered in response to the decision tree(s) generated, for example, from the medical treatment plan databases 706. The information may come from the analysis module 325. The information may or may not be in response to a questionnaire. Information may come from economic information database(s) 410. The economic information database(s) 410 may include information specific to the user.

The economic information database(s) 410 may include aggregate data which may be used to characterize the user. For example, based on the user's ZIP code, certain median household attributes may be determined for the user. The economic information database(s) 410 may include data provided via an interface 305 or 310 or retrieved from any well-known economic database. The economic information database 410 may include medical procedure costs as well as insurance information including costs. The information may be used, for example by the data analysis module 325, to provide the user with a “personalized economic model.” In some implementations, the data analysis module 325 of the health care server 220 curates the aggregated user information, economic information, as well as the information contributed by the information database(s) to provide the user with personalized patient relevant medical information output 412.

For example, the system may store the medicines taken by a patient, and, based in part on the medicines, provide relevant medical information output 412. This patient relevant medical information output 412 may be stored in the user personal record 404 by the data management module or provided to a user or third party such as the patient's provider (if required in accordance with HIPAA regulations) via the interface modules 305 and 310. The PPRMIO may also be generated in a format in which the user may print and/or share with third parties, for example a physician during an appointment.

Treatment plans from the medical treatment plans database 406 (may include decision support tools) are created by subject matter experts and may include at least one of flow charts, trees or diagrams, heuristic techniques, nomograms, questionnaires, and any other well-known logical analytical methodologies. This information may incorporate input via a third party device 215 using the third party user interface module 310.

When questionnaires are present (or any analytical method which requires the user's input), the user enters additional information in response to the questionnaires, potentially as part of a decision tree analysis, designed to guide the user to the most relevant information which may involve a patient's treatment plan. The additional information may be stored by the data management module 320 in the user personal record 404. This additional information may include the user's symptoms for example in the instance of a healthcare related decision tree questionnaire. This additional information can include, inter alia, a patient's symptoms and/or side-effects potentially from medication(s) or procedures or treatments or medical device use. Over time, the system may aggregate patient information across a patient population which may provide valuable information to physicians, hospitals, pharmaceutical companies, and/or medical device companies about different factors or aspects of the treatment plans such as potential harms or unexpected advantages gained by patients during treatment as well as during and after clinical trials.

A decision tree(s), which may be part of a treatment plan, may be created by subject matter experts at any time, independent of the user's activities or timing. For example, the decision trees may be pre-determined and/or may be edited by subject matter experts over time. Decision tree subject matter experts may be experts in decision tree making or experts in the underlying content (i.e., relevant medical treatment plans) upon which the decision tree is based. A subject matter expert may edit/input patient related and/or medically related information and/or treatment plan related information via a user/third party device 210, 215 at the input interface 402 provided by the user/third party interface module 305, 310.

The information database(s) 408 may store additional inputs and/or edits from any of: subject matter experts, the general public potentially in a manner similar to peer-sourcing or crowd-sourcing from an expert database 418, and in one embodiment, hospitals, pharmaceutical organizations, medical device organizations, other health related organizations, and individuals affiliated with these groups. These inputs may or may not be specific to the user/individual patient. The information database(s) inputs and/or edits may be made at any time to the database 418, independent of the user's activities or timing.

Any subject matter expert's rights to edit the information database(s) 408 are pre-determined or at least independent of the user's activities or timing. In one embodiment, the information includes healthcare topics and subject matter experts that are relevant healthcare experts who may include healthcare organizations, physicians, nurses, researchers, etc. In one embodiment, the data management module 320 is configured to control which parties (users, third parties) are able to modify certain information or add certain information.

The medical treatment plans database 406 and medical information database 408 may take the form of a Wiki Medical Information Database (“WMID”) and a Wiki Medical Plan Database (“WMPD”), respectively. A Wiki Medical Information Database contains much of the information that a patient or their caregiver may want to learn about a disease with the exception of diagnostic and treatment plans which are stored separately in WMPD described below. A Wiki Medical Plan Database contains both treatment as well as diagnostic plans. Medical plans may include medical protocols, guidelines, recommended actions, standards of care, and diagnostic or treatment processes. Treatment protocols for each disease may include a treatment plan, summarized consensus statements as well as information addressing relevant practical issues. Diagnostic protocols may include expert decision trees that help guide a patient through (a) medical information database(s) 408.

In one embodiment, the system is an outpatient disease management system which uses the personalized patient relevant medical information output (“PPRMIO”) 412 from a disease management system in conjunction with data from a patient support community 432. The personalized patient relevant medical information output 412 is selected, for example, to comply with any potential requirements with HIPAA regulations, transmitted to a support community 432 via the third party interface module. The support community may include one or more third parties using third party devices 110 permitting greater access for healthcare institutions to their patients post-diagnosis and/or after the patient leaves the healthcare facility and/or in the delivery of ambulatory care. The patient support community 432 (PSC) may be leveraged through ongoing communications with the user (i.e., patient) in the form of PPRMIO 412 in order to maintain user compliance with any plans of action, treatments, or therapies, which may be multiple, prescribed in the personalized patient relevant medical information output 412. In particular, input from the user and third party may be received at the PM server 120 via the network 130. The data analysis module can modify the PPRMIO 412 in response to the received communications.

The patient support community (PSC) 432 may be virtual, on the web for example, or physical potentially through organized gatherings. The patient support community 432 may also include red flag functions which may be connected to monitoring technologies to keep track of compliance through notification to the patient, the patient advocate, and/or the patient's healthcare provider. For example, healthcare providers and/or the patient (or any member of the support community) may be alerted when the patient fails to follow through on his or her prescribed treatment or patient vital signs are outside an ideal range. Moreover, providers and/or patients (or any member of the support community) can specify when they want to be notified. For example, providers can specify to be alerted of certain milestones or symptoms or patient non-compliance over a specified time. Communications to, from or among the patient and other interested parties may be through at least one of the web including chat, voice-over-IP or video or IP, phone, cell-phone, carrier mail, email, text message, medical device, social networking/media and other telecommunication devices. The patient support community 432 may be closed by default in the sense that no one outside the individual patient's support community 432 may see that patient's dashboard or any other information related to that patient. Privacy controls/settings are available to users (e.g., patients) to customize which members of the patient's support community may see and/or modify/delete/edit different patient related information. In sum, the virtual community and its multi-channel communication system facilitates ongoing monitoring of the patient as well as communication/information exchange among the patient and the support community members.

The PSC may create and sustain a supportive group or community for providing patients with motivation, personal coaching and monitoring, spiritual guidance (through “spiritual guides”), and emotional support or even positive “pressure” through peer support as well as education. The PSC provides the tools to motivate patients by helping them achieve “mastery” through education regarding their treatment plans. The Patient Support Community guides a patient to ensure that the patient is following through with the prescribed diagnosis and/or treatment steps, including visits to the patient's healthcare providers. In addition, the PSC may specify the potential dangers of non-compliance. Not only is this “hands-on” monitoring approach effective, this form of “peer support” that accompanies it is known to positively impact patient behavior to comply. Furthermore, the PSC can help patients by establishing an emotional connection, “relatedness”, with other patients with similar diseases. The physical network may also include face-to-face meetings of the PSC members to provide the emotional connections necessary for optimal implementation of the PSC.

The disease management system uses an algorithm to create a personalized Patient Support Community around each patient with friends & family, the patient's care givers and representatives, volunteers, those who provide spiritual guidance (“spiritual guides”), healthcare providers and other patients with similar indications and treatments. The algorithm matches each patient with other patients who have volunteered to help patients like themselves. Patients may also be matched based on their general preferences, diagnostic codes (SNOMED, HL7, ICD9, ICD10, etc.), indications, treatments, geography, and personality attributes.

The Patient Support Community 432 may be chosen to have participants that provide the patient with a diverse and holistic treatment support may include at least one of friends and family, mentors, buddies, subject matter experts, healthcare providers which may include ancillary service providers such as case managers, social workers, nutritionists, pharmacists, rehab professionals, providers of spiritual guidance (“spiritual guides”), etc. and advocates. Buddies may include peers. Mentors may be those who have been through experiences which may provide guidance or relief to the patient. Advocates may be those who build support for a cause related to the patient's interests. The PSC communications may also be stored in the user (“patient”) personal record 404 by the data management module 220.

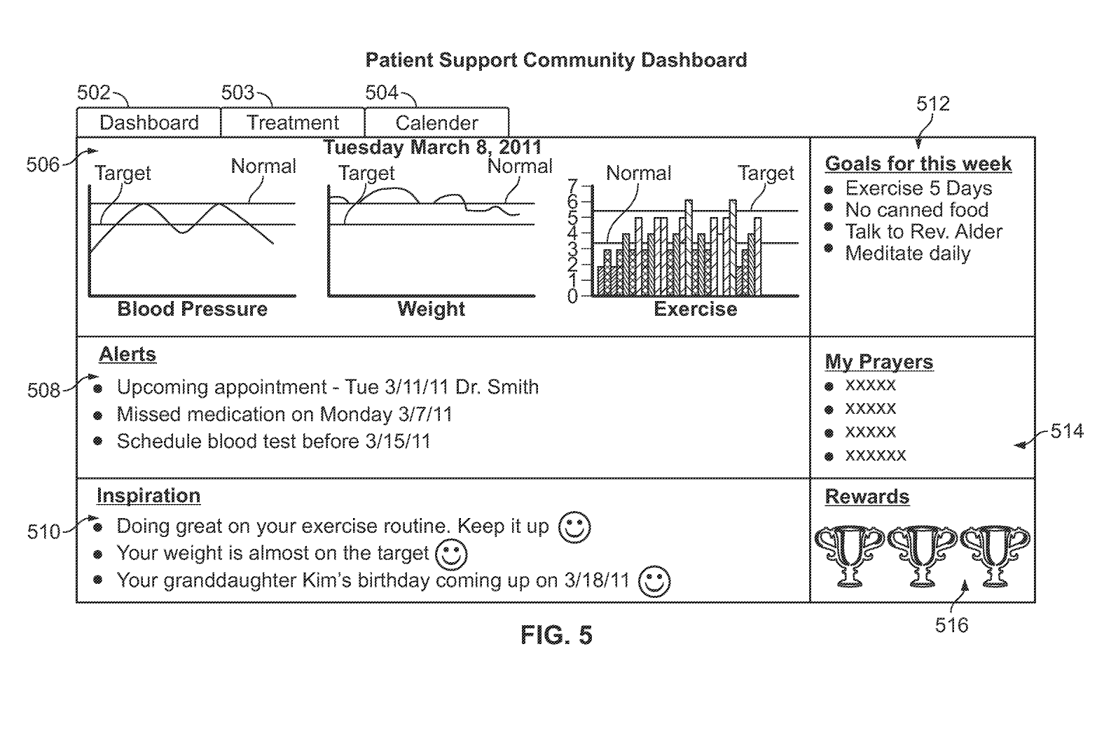

Members of a Patient Support Community may share a common interface that displays the status of the patient's treatment and how the patient is doing and how well they are adhering to their treatment. For example, a patient dashboard may be communicated to a device via one of the described interface modules (e.g., 205, 210 in FIG. 2). An example dashboard will be described in further detail below in reference to FIG. 5.

As part of the system shown in FIG. 3, healthcare providers (healthcare organizations, physicians, nurses, etc.) may enter patient specific diagnostic and treatment information 416 into the information database(s) 408, such as the storage 225 via a third party device 115 using the third party interface module 210. This or any other patient specific information (as well as any information from groups 418 described above) entered may be used by the data analysis module 325, using, for example, treatment decision trees that may be specific to the patient and may address ongoing treatment plans. Treatment decision trees may be designed to facilitate data capture by the providers, following up with patients and ensuring patient compliance with therapies and treatments. In this embodiment, the same bilateral communication methods, as well as the use of red flags and monitoring technologies, used by the patient support community 432 are available to the healthcare providers. This information may be stored in the user personal record 404 by the data management module 220. The multi-channel disease management system in FIG. 3 may also be served by the medical treatment plan database(s) 406 and information database(s) 408 in ways analogous to that seen in FIG. 3 and described above.

The system in FIG. 3 may serve multiple purposes, including providing compliance management for patients having several specific medical conditions. The system may also use the stored data to provide an extensive user personal record 404 in order to provide healthcare entities such as healthcare organizations and individuals who provide healthcare service with inclusive operations research data regarding patient compliance during and after treatment.

In one embodiment, the disease management system begins when a doctor selects a diagnostic or a treatment plan for a patient. The disease management system implements that diagnostic or treatment plan to monitor, support, motivate and educate the patient about their disease every step of the way. This allows the patient and their health care provider know the various steps in the diagnostic or treatment plan and what is required of the patient each step of the process. In addition, the system has data and reminders to ensure that the patient and the care provider are aware of and compliant with upcoming events such as appointments, and to keep a dashboard for the patient to inform all members of the care team of pertinent medical information. The dashboard, as described below can be used as a central communication interface between the patient care members.

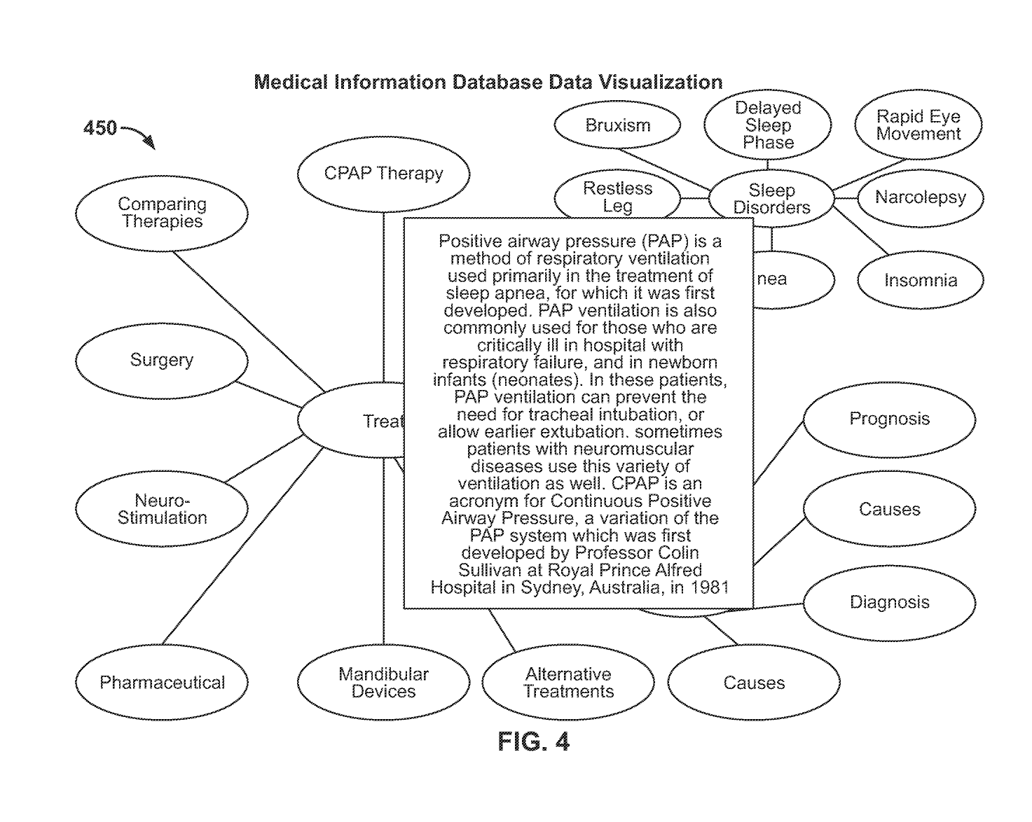

FIG. 4 shows a medical information data visualization 450 of a disease management system information database in accordance with an embodiment of the disclosure. FIG. 4 is a graphical representation of some of the information in the medical information database 408 related to, for example, sleep apnea, a major sleep disorder. The graphic depicts what may be seen by a patient using one of the described interface modules (e.g., 305, 310 in FIG. 2). This use of data visualization augments the patient's (or any user) learning process with regards to the patient's specific medical condition which in conjunction with the disease management system ultimately results in a more informed, satisfied, and compliant patient.

Each node (e.g., “Sleep Disorders”) in FIG. 4 contains specific information about the various aspects of sleep disorders and specific information about the various aspects of sleep apnea. (In FIG. 4, the “Sleep Apnea” node is hidden under the PAP pop-up box.) Each node includes an “information” link which when the node is double clicked (or any other programmed method of user entry) the user is shown more specific or granular information. For example, the “Sleep Disorders” node is linked to various nodes such as “Insomnia” and “Narcolepsy” which are shown as depicted in FIG. 4 when the “Sleep Disorders” node is double clicked (or any other programmed method of user entry). Alternatively, links may represent attributes for nodes which include: causes (which may show the causes for a disease), treatments (which may show various treatments such as “Surgery” in FIG. 4 for a given disease represented by a node), etc. When the “Treatment” node (partially hidden in FIG. 4) is double clicked (or any other programmed method of user entry) the user interface may be configured to show different attributes such as “Surgery” and “Pharmaceutical” as seen in FIG. 4.

The graphical representations of the information in the system databases can vary dependent on the specific patient's diagnosis. For example, the system is configured to handle showing only treatments relevant to a patient's diagnosis. If a patient is deemed not a candidate for surgery, then they may be unable to visualize a surgery treatment node such as that seen in FIG. 4 when they are viewing options available to them.

In addition, FIG. 4 illustrates more details regarding sleep apnea using a pop-up box, a graphical user interface display area, which includes, inter alia, high level information regarding the disorder. The pop-up is shown when a user scrolls over and right-clicks (or any other programmed method of user entry) on a node of interest. An “overview node” (“Comparing Therapies”) is also provided representing detailed information comparing the various therapies. When a user clicks (or any other programmed method of user entry) on the comparing therapies, a separate table of comparing therapies is shown.

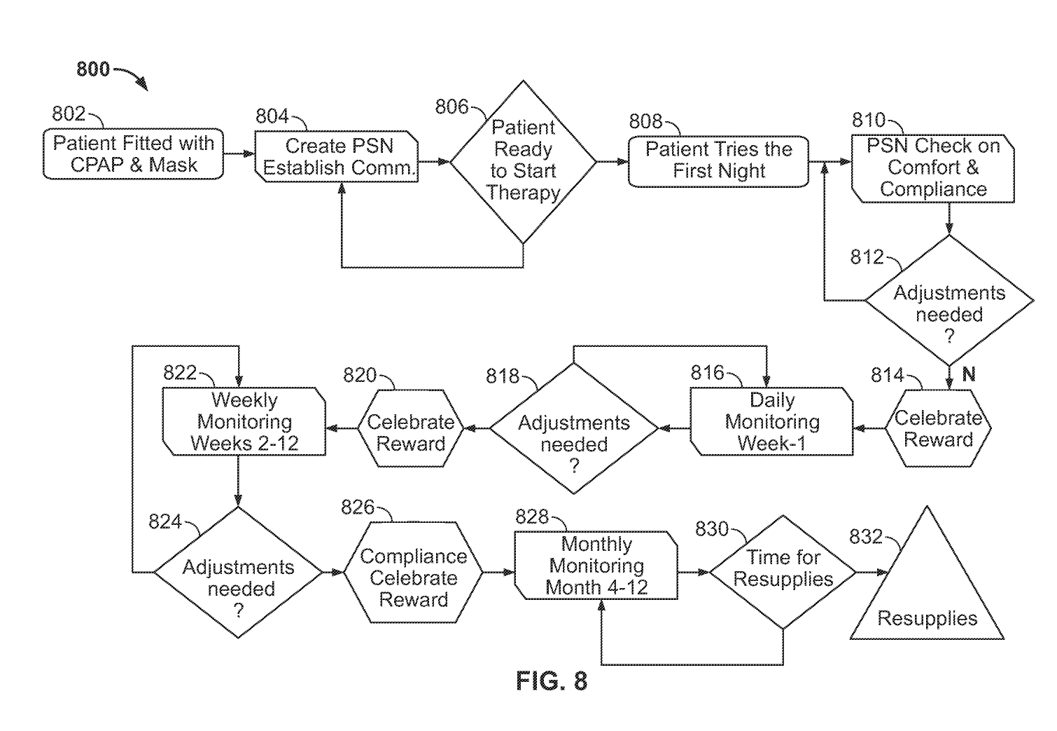

To simplify information navigation and information capture, semantic network data structures such as those in FIG. 4 are used to capture, store, display, and navigate information in the medical information database 408 and the medical treatment plan database 406. This semantic network represents the semantic relations among concepts and is a directed or undirected graph that may include vertices, which represent concepts, and edges. In the medical information database 408, the nodes of the visualization 450 represent information about various aspects of a disease and the directed or undirected links (edges) represent relationships between any two nodes. For example there may be a node representing obstructive sleep apnea (OSA) and another node representing Congestive Heart Failure (CHF). Each of these nodes may contain other graphs providing details about each disease. A link between an OSA node and CHF may represent a co-morbidity relationship established between the two diseases based on numerous studies. This link or edge may then represent the body of evidence and detailed articles that establish such relationship between the two diseases. In the medical treatment plan database 406, nodes may represent information, an action that needs to be taken (for example a medical test), and/or decision points. Based on the outcome of a decision point, the healthcare provider may follow one of the possible outcomes from that point in the diagnostic plan, such as that described below and shown in FIG. 8.

Over time, the semantic network data structures in the disease management system databases evolve to reflect their past usage or any edits made by subject matter experts. For example, if one of the sleep disorders is known to be, or becomes, much more prevalent than the others, then its “node” may be displayed in a larger size on the display to the patient. Accordingly, the size of the node, which may be shaped as an ellipse, may be made visually larger to the user to indicate its increased importance. Again, the user may views these graphs using the user interface modules 305 or third party interface module 310 in FIG. 2.

Moreover, the semantic network data structures in the disease management system databases may use information visualization techniques, in addition to the pop-up box discussed above, facilitating the system's ease of use. For example, as the user is navigating the semantic network in FIG. 4, the node last clicked may be seen visually at the center of the user or third party interface module which may be a monitor. If “Treatment” was the last node clicked, then the “Treatment” is at the center of the interface module. As a user navigates further away from a node, the smaller the node gets and the further it gets from the center of the interface module. For example, looking at treatments for OSA, the “Insomnia” node may be made visually smaller and further away from the center of the interface modules. These information visualization techniques are employed to expedite learning for the user. The graphical displays allow intuitive navigation of the contents of system databases highlighting the relationships between various topics in the information databases and the various treatment plans in the treatment plan databases.

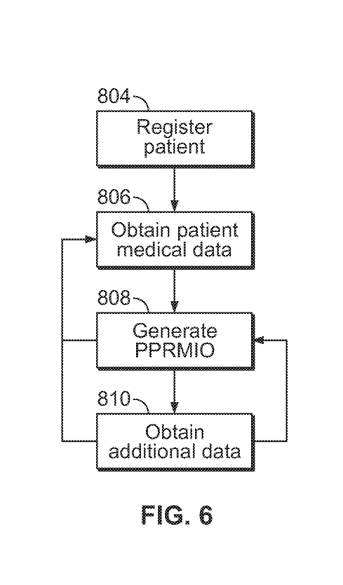

FIG. 5 shows a patient support community dashboard of a disease management system in accordance with an embodiment of the disclosure. FIG. 5 illustrates a non-limiting example of a patient dashboard. The dashboard may represent a display page for information associated with the logged in patient. The Patient Treatment Dashboard (“PTD”) highlights and logs important dates such as visits to doctors or labs, as well as related news, spiritual information including prayers, progress reports, alerts, goals, symptoms and rewards information. The rewards system will be discussed in more detail with regard to FIG. 6. The patient dashboard is programmed to solicit the patient or member of the patient support community for the patient's updated vital information throughout a treatment plan. The patient dashboard is the focal point for the Patient Support Community discussion which fosters and accommodates personal coaching and continuity of care across multiple healthcare providers. The dashboard is a motivational tool which provides the patient with a sense of autonomy with regards to their treatment plan. For example, the dashboard may present the patient with congratulatory messages if certain health milestones are achieved (e.g., weight, blood pressure, sustained weight, glucose levels, compliance with prescription regimen, exercise). The dashboard may be configured to present rewards as determined, for example, by the rewards module 340. Presentation of rewards may be graphical (e.g., icons, badges) or textual (e.g., pop-up messages, status messages). The dashboard may be further configured to enable redemption of the rewards.

The interface shown in FIG. 5 may be configured to display various information from the patient support community for the logged-in user. The interface may include a dashboard tab 502. When an input signal is detected on the dashboard tab 502 such as a mouse click, the dashboard may be shown. Other tabs included on the patient support community interface may be a treatment tab 503 and the calendar tab 504.

When activated by a mouse click or technological equivalent, the treatment tab 503 may present an interface displaying various aspects of the treatment program for the logged-in patient. In one implementation, clicking the treatment tab transmits information identifying the logged in user to the health care server. The health care server may obtain treatment information from one or more electronic storages or servers associated with the health care server. For example, the treatment information may include prescribed medications, exercise routines, dietary actions, and the like.

When the system receives an indication to display the calendar tab 504 (e.g., mouse click), an interface displaying events of interest or events associated with the logged-in user may be displayed. For example, the calendar may display upcoming healthcare information such as upcoming presentations of interest based on the patient's condition. For example if the patient is recovering from pulmonary edema, information pertaining to an upcoming speech given by a prominent cardiologist may be displayed in the calendar view. The calendar may also include appointments for the patient with members of the patient's medical team. As with the treatment tab 503, when a user clicks on the calendar tab 504, information identifying the patient may be transmitted to the health care server. Based on the information transmitted, the health care server may obtain specific calendar events for the user, such as doctor's appointments, as well as general calendar events of interest based on one or more attributes of the patient, such as their condition, location, medical history, prescriptions, support community, and the like.

The interface shown in FIG. 5 represents an example of a dashboard interface. A dashboard interface may include a statistics panel 506. The statistics panel 506 may present various statistical information about the patient's condition. As shown, the statistics panel 506 includes a blood pressure graph, a weight graph, and an exercise bar graph. These graphs chart a patient's progress for a particular health attribute over time. In some implementations, the patient may input their blood pressure, weight, or exercise level on a periodic basis (e.g., daily, weekly, monthly) as requested by their physician. The information entered through the interface may be associated with a patient and stored in the health care server. For instance, the system may assume that a patient logging into the system will enter his or her own medical and patient-specific information. In some implementations, a member of the patient support community may have permission to enter information for a patient they support. In general, each entry is accompanied by one or more data elements that can be used to identify the patient with whom the entry should be associated. Example identifiers may include patient name, patient hospital identifier, email address, phone number, and health care server identifier.

The information may be input through an input field. One type of input field, such as via an HTML web form, may accept input directly through a dashboard interface. In some implementations, the system may include a text messaging module to receive the information from a patient via text message. The input field of the text message may include the body of the text message. In some implementations, the system may be configured to parse a specific format (e.g., comma separated message; newline separated message) representing one or more input fields. The health care system may be configured to receive the text message and, based in part on the phone number from which the message was sent, identify the patient and associate the message with the patient. Similar methods may be used to accept email entries wherein the sender's email address is associated with a patient. Thus, the patient can send an email message to a specific email address associated with the system and the system will parse and read the email message to determine the proper information and associate it with the patient's record. For example, the patient may email or text heart rate or blood pressure measurements in a pre-determined format to the system, and the system would thereafter store that information with the patient record for future analysis. In some implementations, particular measurement devices may transmit the information to the system. For example, a digital heart rate monitor may be configured with patient identifying information. When the heart rate monitor completes a reading, the monitor may transmit the identifying information along with the reading to the health care server through a wireless or wired access network. In still other implementations, data may be entered via an IVR (interactive voice recognition) system. For example, the system may include a calling module which is configured to call the patients, ask them questions, record the response(s), and fill the appropriate data field(s).

In some implementations, the information to be displayed may be configurable for each patient. For example, a doctor may determine that weight, blood pressure, and exercise are three areas a particular patient should pay attention to. The doctor may indicate these as “high-priority” health attributes. The system may then be configured to collect these attributes and display this information more prominently than an attribute which is of lower priority. The system may also be programmed to send reminders to the patient that the required data still needs to be input into the system. Other health attributes include blood sugar level, calorie intake, experience of pain, or pulse may also be received by the system and used to monitor the health and well-being of the patient.

In the general view of the dashboard, a patient may track their progress over time. Also shown in the statistics panel are normal and target benchmarks for each statistical graph. Using a configuration interface, normal and target values for each metric may be established. For example, a doctor may provide a normal blood pressure in addition to a target blood pressure for a specific patient. In some implementations, the normal and/or target values may be determined based on preconfigured data stored by the health care server. The normal and target values may be further determined based on specific attributes of the patient. For example, the health care server may calculate a normal or target blood pressure for a patient in consideration of personal factors such as age, weight, height and so on.

A patient may provide permissions to view one or more panels for members of the patient support community. For example, the patient may want their friends to see the statistics panel 506 but no other information about their treatment program. As such the health care server may determine which elements (e.g., panels, tabs, messages) to present based on the user's relationship to the patient and the permissions granted to the user by the patient. Permissions may be assigned by a patient at an individual level, a group level (e.g., all care providers, all doctors, all friends, etc.).

The dashboard may include an alerts panel 508. The alerts panel 508 may list upcoming or important information related to the patient. When a user logs into the system, identifying information for the user may be transmitted to the health care server. Using the identifying information, the health care server may identify specific events for the user such as a doctor's appointment or a missed medication administration. The identifying information may also be used to search the information storage associated with the health care server for relevant and important information, such as immunizations or an upcoming clinical trial.

The patient support community dashboard may also include an inspiration panel 510. The inspiration panel 510 may present inspirational messages for the patient. The inspirational messages may be selected from messages stored in the health care server. Alternatively, the inspirational messages may be provided by members of the patient support community that are stored and then sent to the patient at a particular time or stage of treatment. For example, a friend may notice that the patient's weight is trending toward their target. The friend may submit an inspiration message using a user interface to the patient. When the patient logs on to the system, the health care server may render the inspiration message from the friend in the inspiration panel 510. Inspiration panel 510 may also render inspirational images. As shown in FIG. 5, the inspiration messages includes happy faces but may also render other images such as flowers, kittens, serene landscapes, clowns, or other whimsical elements for the patient. In some implementations, an inspirational message may include digital pictures, multimedia content, audio content, and other interactive content. In some implementations, the user may configure the number of inspiration messages to be displayed on the inspiration panel 510. In some implementations, the inspiration messages are displayed based on when the message was received by the system. The patient support community dashboard may also include a goals panel 512. The goals panel may present one or more goals for the patient. When the patient logs onto the system, identifying information may be transmitted to the health care server which may be configured to retrieve the goals for the patient. In the example shown in FIG. 5, weekly goals are presented. Daily, monthly, quarterly, or other time frame goals may also be presented. The goals may be selected from general goals stored in the health care server based in part on a co-morbidity for the patient. In some implementations, if the user has diabetes, a weekly goal of taking five consecutive blood sugar readings may be presented. The goals may be selected from specific goals stored in the health care server for a particular patient. As shown in FIG. 5, one goal is to “Talk to Rev. Alder.” The patient specific goals may be entered into the system by the patient or another member of the patient's support community. As described above, which members of the patient support community t permitted to enter goals may be controlled through permissions set by the patient and enforced by the health care server.

The patient support community may also include prayers panel 514. The prayers panel 514 may include prayers contributed to the system by the patient or another member of the patient support community. The prayers may be displayed in the order submitted to the system. The prayers may also be selected from general prayers entered into the system based on an attribute of the patient such as religious belief, medical history, age, location, etc.

The patient support community dashboard may also include a rewards panel 516. As shown, the rewards panel 516 may display icons such as trophies which may represent successes for the patient (e.g., health milestones achieved). In some implementations, the rewards panel 516 may be configured to present commercial rewards to a user. For example, if a user achieves a target weight, they may be offered a coupon for a healthy yet delicious snack. The rewards may be selected at random by the health care server. The rewards may be selected based on attributes of the patient, such as the patient's medical condition, the patient's location, or other factors that may further tailor the reward to entice the patient to continue with their treatment plan.

In some implementations, the rewards panel 516 may also include a rewards redemption module. The rewards redemption feature may be configured to send a message to a patient to redeem a reward earned. For example, in some implementations, rewards may take the form of points. Each event performed by the user on the health care server may generate points (e.g., enter health data is worth three point, entering a prayer is worth one point, achieving a target metric is worth ten points). The rewards panel 516 may display merchandise or other prizes that may be obtained in exchange for the points earned by the user. As with the coupon, the point rewards may encourage a patient to actively participate in their wellness program. The point values for each event may be configured by a doctor to help ensure proper incentives for the specific patient. In some implementations, the point values may be configured globally, that is the same for all patients. This feature may be implemented by storing point tallies with each patient record, and having an associated table or database that associates a specific goal with a particular number of points. When the goal is reached, the system allocates the predetermined number of points to the patient.

In one embodiment, any member of the Patient Support Community can access the dashboard using any browser, mobile app, telephone or other applicable device. The patient support community member can view the patient's input, the patient's vital signs, the patient's progress on their treatment plan, and the patient's adherence to their treatment plan (or lack thereof), among other things including reporting updates regarding the patient's progress toward or against the patient's treatment plan.

The system is also capable of engaging members of the patient support community for a variety of reasons. For example, if the patient is not connecting to the patient support community, the patient's vital signs are not improving or getting worse or being updated, the patient's condition is not improving or getting worse or being updated, and/or if the patient is not showing up for his or her appointments. In addition, the system may contact the patient as per their treatment plan to ask the patient if they have taken their medication and/or if they are following their diet and exercise plans.

Thus, the Patient Support Community uses interactions across the dashboard and system to motivate a patient to comply with their treatment plans through peer support; tools for a patient to gain autonomy, mastery and relatedness with regard to the treatment; and a clear picture or purpose through hands-on guidance and personal coaching for the patient during their treatment plan.

FIG. 6 shows a process flow diagram for a method of using the disease management system. At block 804 a patient is registered with the disease management system. The patient may be registered automatically as part of discharge from a hospital. The patient may elect to register with the system by accessing the server through a device. The patient may be registered by a care provider, doctor, or support community member. The registration process includes providing identifying information about the patient, contact information for the patient. In some implementations, it is desirable to perform the registration process via a secured channel such as HTTPS, SSL, or other protected medium.

At block 806, patient medical data is obtained. The patient medical data may be obtained from a hospital. The patient medical data may be obtained from a doctor. The patient medical data may be obtained from the patient or another actor of the system through an interface to the system. For example, the doctor may establish certain health milestones for the patient such as a target weight. The health milestones received for the patient may be stored in a memory and used for further processing. The obtained information may include a message about a patient from one actor to another actor. Medical data may include demography or activity information such as smoking, level of alcohol intake, gender, ethnicity, age, and the like.

Which patient medical data that is obtained may be configurable. In some implementations, it may be desirable to track only a few attributes for a patient. This may improve the likelihood of a patient complying with the tracking. The attributes to be tracked may be specified by another actor of the system, such as a doctor. Using the third party interface, for example, a doctor may identify several attributes from a menu of attributes to be tracked for a patient. When the patient accesses the user interface, the system may present the specified attributes. In some implementations, values for other attributes may optionally be presented, but the patient may not be required to enter values for the optional attributes.

In some implementations, information provided at registration may be used to obtain the medical information. For example, a patient identifier assigned to a patient while in the hospital may be used to retrieve a continuity of care record from the hospital upon discharge. The information may be used to retrieve the medical information in an automated fashion through a machine interface. The information may be retrieved in bulk (e.g., an entire continuity of care record). The information may be obtained on demand (e.g., when the patient accesses the system).

Patient medical data may include information about care providers, hospitals, doctors, and support community members. The process may be configured to allow a patient to set permission levels to control the access of the various actors. For example, a patient may want to allow a friend to view their progress, but not have access to medication schedules. The permissions may also be configured to alter the functions of the system such as messaging. For example, a patient may not want to allow certain members of the patient support community to send messages using the system. Accordingly, the patient may configure the messaging options for the members of their support community.

The obtained patient medical data may be stored in memory. The obtained patient medical data may be processed prior to storage to standardize the information. In some implementations, the patient medical data is obtained on-demand. For example, when a user accesses the system, the patient medical data is retrieved from one or more stores. The patient medical data may not be stored in this example, but rather persisted in temporary memory for the length of the user session. Upon log out the patient medical data is removed from the system. Although described as two alternate modes of operations, as the HC server may aggregate many types of information from many sources, patient medical data may be obtained from on-demand as well as sources that provide data that is maintained in storage between user sessions.

At block 808 personalized patient relevant medical information output is generated. The PPRMIO may be generated by the data analysis module, the education module, or other module of the system. The PPRMIO may include selecting educational content such as articles or videos. The selection may be based on the stored patient medical data specific to the patient. The selection may be based on co-morbidity information. The selecting may also include organizing the educational content into a curriculum. A curriculum may include a collection of educational content or other medical information (collectively referred to as an element of the curriculum), organized in a particular sequence for presentation to a user. For example, each item of selected educational content may be compared and arranged into a logical sequence for presentation to the patient. In one implementation, an article identified as a basic introductory article may be placed at the beginning of the curriculum while a more advanced article may be placed later in the curriculum. In one embodiment, the article may be identified through automated textual analysis, of associations of data that are manually inputted to the system. The curriculum may also be based on system usage information. For example, if heart failure patients within a specific demographic tend to watch a particular sequence of videos, the system may base arrangement and/or content the curriculum on this system usage information. As with the educational content, the curriculum for each patient may be generated based on a patient's information such as the diagnostic or treatment codes. The curriculum may also be further personalized based on what stage of the condition the patient is and how long they have had this condition.

Generating PPRMIO may also include generating a message. For example, as described above, the system may include a messaging module to allow actors to securely communicate. In one implementation, if a patient inputs their weight, a message may be sent to members of the patient's support community. If the patient has input a desirable weight, the support community may be sent a positive message alerting them to the success. If the patient has input an undesirable weight, the support community may be sent a message with suggestions on how to help the patient.

Once the PPRMIO is generated, the flow may return to block 806 to obtain patient medical data as described above. In some implementations, once the PPRMIO is generated, the flow may continue to block 810 where additional data is obtained. The additional data obtained at block 810 may include content, event information, and other non-patient specific information. For example, new content items may be added to the system such as articles, videos, or events. As part of obtaining the additional data, the data may be categorized. For example, keyword extraction may be performed to identify the topic of a particular text article. Optical character recognition may be performed as part of the extraction process. In some implementations, audio to text conversion may be performed.

The flow may return to block 808 to generate PPRMIO in consideration of the new clips. In some implementations, the flow may return to block 806 and obtain patient medical data as described above before generating PPRMIO at block 808. As can be seen in FIG. 6, the personalized information is continually refined as new patient medical data is obtained as well as other data is obtained. This process ensures timely and relevant information is presented for each patient.

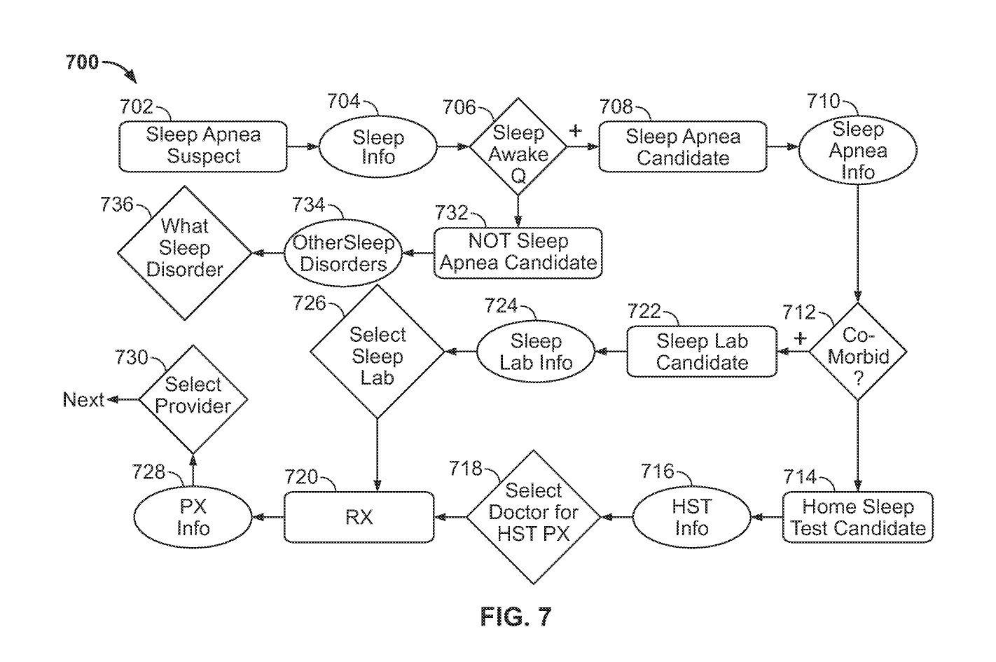

FIG. 7 shows a diagnostic flow diagram of a patient disease management system database in accordance with an embodiment of the disclosure.

Specifically, FIG. 7 shows an example of a flow chart representing a decision tree for diagnosing sleep apnea. These types of decision trees are found in the medical treatment plans database 406 and implemented by the data analysis module 325. This flowchart is used through interface modules described above to walk the patient through step-by-step education about sleep apnea; what decision they or their doctor needs to make at each step, and the consequences of those decisions. In FIG. 7 circles represent information to be displayed to the patient using the interface modules (205, 210) described above; diamonds represent decision points in the diagnostic process; and the rectangles represent steps in the diagnostic process. The information nodes (the circles) point to nodes in the medical information database(s) 408 such as storage 225. The decision outcomes are either determined by the doctor or through questionnaires or other methods to acquire patient data presented to or by the patient or a third party.

As shown in example of FIG. 7, the flow 700 commences at block 702 when a patient suspected of having sleep apnea accesses the system. A patient may be suspected of having sleep apnea based on information entered into the system through a dashboard as described above. A patient may be suspected of having sleep apnea based on other patient medical information included in the health care server. Examples of such medical information may include continuity of care record information, prescriptions, or the patient medical history. At block 704, general sleep information is presented to the patient. At decision block 706, the patient is then presented with “sleep-awake” questionnaire. Values for each question are received by the system. The system determines one or more result values based on the received values. One or more of the received values, result values, date of the questionnaire, and the patient identity may be then stored by the health care system.

The data analysis module may be configured to analyze the results. Analysis may include generating a weighted probability based on a list of factors stored by the health care system. The analysis may use the questionnaire response values to traverse decision trees, as described above, and to generate results value(s). If the results of the questionnaire determine that the patient is not a sleep apnea candidate the flow 700 continues to block 732 where the patient is identified as not a candidate for sleep apnea. This identification may also be stored in the health care system. At block 734, the patient may be presented with information on other sleep disorders. The flow 700 may continue to decision block 736 where a different questionnaire is presented to assist in determining if the patient suffers from any other sleep disorder.

Returning to decision block 706, if the results of the questionnaire determine that the patient is a sleep apnea candidate, the flow 700 continues to block 708 where the patient is identified as a sleep apnea candidate. At block 710, more detailed information about sleep apnea is presented. The information presented may include text, video, audio, or other content to help explain the condition or further diagnose the condition. At decision block 712, a determination of co-morbidities for the patient may be performed. The determination at block 712 may include analysis of existing medical information associated with the patient. The determination at block 712 may include receiving additional health care information (e.g., questionnaire).

If the patient has any co-morbidity, the flow 700 continues to block 722 where the patient is identified as a candidate for sleep lab testing. At block 724, sleep lab information may be presented to the user. The information may be similar in format to the information presented at block 710. Examples of information presented include information about the sleep lab, what to expect at the lab, what kinds of tests they will run, preparation, frequently asked questions, etc. The information may also include a list of sleep labs near their home or work. At block 718, a determination is made to select a doctor for home sleep test prescription. The selection may be made based on user input or based on insurance information provided by the user. For example the system may be configured to present only providers within the patient's health insurance plan. The flow continues to block 720 as described above. When the patient goes to the sleep lab they are then provided a prescription (“Rx”).

Returning to decision block 712, if the patient does not have any co-morbidity, the flow 700 may proceed to block 714 where the patient is identified as a home sleep test candidate. At block 716 home sleep test information may be presented. The information may be similar in format to the information presented at block 710. The information may include information about home sleep testing equipment and processes. At block 718, a determination is made to select a doctor for home sleep test prescription. The selection may be made based on user input or based on insurance information provided by the user. For example the system may be configured to present only providers within the patient's health insurance plan. The flow continues to block 720 as described above.

At block 720, the system may be configured to generate a prescription for the patient (e.g., sleep lab or home sleep test). In some implementations, a doctor may access the health care system and generate the prescription for the patient after reviewing the questionnaire responses and other medical information. Information about the prescription may also be provided (e.g., timing, interactions with other prescriptions). The information may be stored in the health care system and presented based on the prescription code. At block 728, the test results may be analyzed to identify prognoses (“Px”). At block 730, the patient may be presented with a list of options how to select a provider for further services/products based on the prognoses and/or prescription (e.g., where to fill the prescription).

FIG. 8 shows a treatment plan flow diagram of a treatment plan that may be included in a disease management system in accordance with an embodiment of the disclosure. Specifically, FIG. 8 shows an example of a treatment plan implemented by the data analysis module 325 for a sleep apnea patient who has been given a prescription for a continuous positive airway pressure (CPAP) machine for their treatment. The treatment plan may be stored in a medial treatment plan database as described above.

The flow 800 begins at block 802 where the patient is fitted with a proper CPAP machine and proper mask by a clinician. Following this treatment plan, at block 806, the patient management system may prompt the patient (or a third party) to create a personalized Patient Support Community (PSC). In some implementations the Patient Support Community may be referred to as a Patient Support Network (PSN). Once the PSC is formed, the first task of the PSC is to make sure that the patient is comfortable with their CPAP machine and their choice of CPAP mask. At block 806 a determination is made as to whether the patient is ready to start. If the patient is not ready to start the therapy the flow returns to block 804. The patient may use the disease management system to consult with members of their PSC until they are comfortable. If the patient indicates they are ready to begin therapy, the flow continues to block 808.

Now the patient is ready to try their CPAP machine for treatment of their sleep apnea for the first night at block 808. After the first night, the flow continues to block 810. At block 810, the PSC may access the disease management system to determine if the patient was compliant and comfortable with their treatment. The flow continues to 812 where the system determines, based on the PSC check, whether an adjustment is needed for the patient. If an adjustment is required, the flow 800 returns to block 810 to again perform a check on a patient's comfort and compliance. The system may be configured to suggest changes for comfort and/or compliance based on information stored in the database associated with the health care server. For instance, if a user complains that the mask is hurting their ears, an alternative strap configuration may be suggested. The loop between blocks 810 and 812 may be repeated if the patient was not comfortable and or did not use their CPAP machine as instructed. The PSC may take corrective actions until the patient passes through the first night of compliance for their treatment.

Once the patient has passed through the first night of compliance, at block 814 there is a celebration to “reward” the patient for their achievement and to motivate them to continue with their treatment. The disease management system follows the steps outlined in the treatment protocol until the last step in the protocol has been completed.

At block 816, the PSC next monitors the patient on a daily basis for the first week. At block 818, similar to the determination previously made at block 812, the need for adjustments is determined. If there is a need for any adjustments, the PSC may communicate with the patient to address them (e.g., messaging through the health care system, telephone call, email). At block 820, after the patient has successfully completed the first week of compliance, there is another celebration. At block 822, weekly monitoring may continue an adjustment cycles at block 824 may be performed at block 826 a compliance celebrate reward may be presented to the user. Continuing to block 828, monthly monitoring may continue for the next 4 to 12 months. At block 830 if supplies used during the test are determined to be depleted, the flow may continue to block 832 to obtain a resupply. For example the protocol may include a disposable component which is used once. As such, the patient may require additional components to continue the therapy. Because the system may be monitoring the progress of the therapy, the system may also infer the number of components remaining and suggest a time for reorder. Reorder suggestions may be made based on providers that accept the patient's insurance, providers located near the patient, providers that deliver, featured providers (e.g., providers having a “special” on the product to be reorders), or other factors.

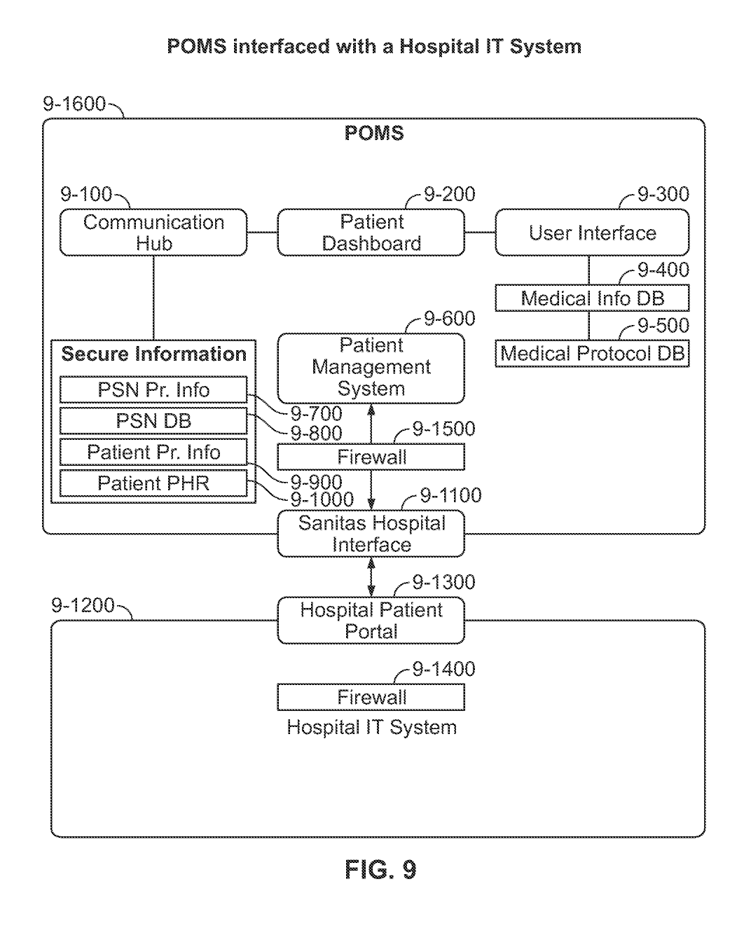

FIG. 9 is a network diagram which shows an embodiment of a personalized disease management system interfacing with a hospital IT system. In particular, FIG. 9 shows an embodiment of a personalized outpatient management system (POMS) 9-1600 interfacing with a Hospital IT System(s) 9-1200. The personalized outpatient management system (POMS) 9-1600 includes the elements inside of the top large rectangle. The Hospital IT System(s) 9-1200 includes the elements inside of the bottom relatively smaller rectangle. FIG. 9 is not to scale and is provided for descriptive purposes. FIG. 9 may not truly reflect the configuration of POMS and its connections to a Hospital IT System and is meant only to show the different parts of the system at a high level of granularity/detail. The exemplary POMS 9-1600 includes a communications hub 9-100 for unified messaging to support patient support community activities and interfaces, a patient dashboard 9-200 such as that disclosed above and depicted in FIG. 5 which provides patient treatment update info, a user interface (I/F) 9-300 such as 205 and 210 in FIG. 2 permitting user login amongst other functions, a medical information database 9-400 such as that disclosed above used for patient education, a medical protocol (or treatment plan) database 9-500 such as that disclosed above for various diseases/conditions, and a disease management system 9-600 such as that disclosed above. Databases 9-400 and 9-500 may be non-patient specific and are organized using semantic network data structures including nodes and edges.

The exemplary POMS in FIG. 9 also includes an encrypted and secured patient support community (PSC) such as that disclosed above comprising PSC profile info 9-700, a PSC database 9-800, patient profile info 9-900 and patient Personal Health Records (PHR) 9-1000. The exemplary POMS includes a hospital interface 9-1100 which links firewall 9-1500 to POMS to a hospital IT system 9-1200 consisting of a patient portal 9-1300 and a firewall 9-1400. The patient portal provides patients with access to electronic health records and hospital services which may include email, test results, appointments, etc. The hospital interface 9-1100 includes modules customized for each hospital to interface through their patient portal. POMS rely on patient diagnostic codes (e.g., SNOMED, HL7, ICD9, ICD10) which may be extracted from the system databases including the patient PHR database 9-1000).

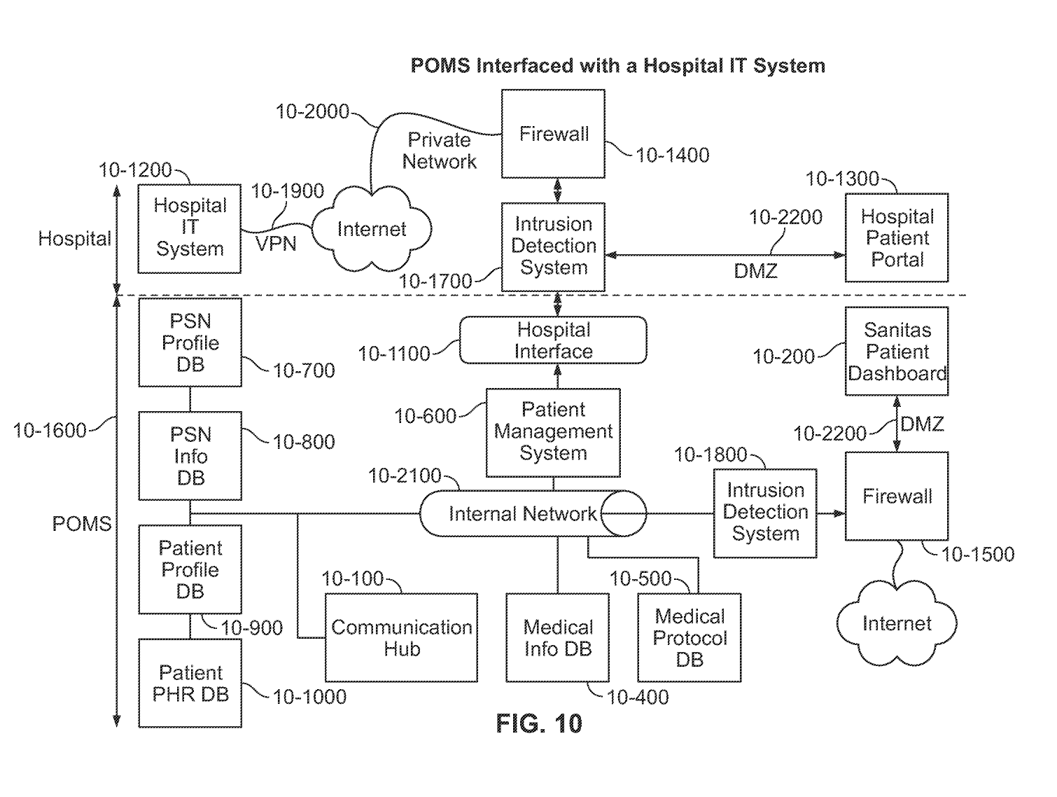

FIG. 10 is a network diagram which shows another embodiment of a personalized disease management system interfacing with a hospital IT system. In one aspect, FIG. 10 is shows a personalized outpatient management system (POMS) 10-1600 interfacing with a Hospital IT System(s) 10-1200 through private networks 10-2000, VPN (virtual private network) 10-1900 and the internet. The exemplary POMS includes at least two intrusion detection/prevention systems 10-1700, 10-1800 as well as DMZs 2200 (demilitarized zones) (all in addition to firewalls) and an internal network 10-2100. FIG. 10 is not to scale and is provided for descriptive purposes. FIG. 10 may or may not truly reflect the configuration of POMS and its connections to a Hospital IT System and is meant only to show the different parts of the system at a high level of granularity/detail. The configuration shown in FIG. 10 may be used to implement the system shown in FIG. 9.

While for the sake of illustration a specific relative ordering of components is shown, it will be readily apparent to one of ordinary skill in the art that these components may be configured in relative orderings and uses other than those shown and described.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the disclosure. In addition, the grouping of functions within a module, block or step is for ease of description. Specific functions or steps can be moved from one module or block without departing from the disclosure.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The description provided herein uses specific embodiments for the purposes of illustration only. It will be readily apparent to one of ordinary skill in the art, however, that the principles of the disclosure may be embodied in other ways. For example, the medical information database(s) 408 may not be a required component in the disease management system. In addition, characteristics/components/descriptions of the disease management system (e.g., patient or outpatient management systems) can be used interchangeably. Therefore, the disclosure should not be regarded as being limited in scope to the specific embodiments disclosed herein, but instead as being fully commensurate in scope with the following claims.

The above description of the disclosed embodiments is provided to enable any person skilled in the art to make or use the systems, methods, and apparatus described herein. Various modifications to these embodiments will be readily apparent to those skilled in the art, and the generic principles described herein can be applied to other embodiments without departing from the spirit or scope of the disclosure. Thus, it is to be understood that the description and drawings presented herein represent a presently preferred embodiment of the disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly limited by nothing other than the appended claims.

What is claimed is:

1. An on-line patient monitoring system, comprising:
a display interface configured to display patient health data;
an input field configured to receive updated medical data from the patient;
a relationship module configured to maintain relationships between the patient, a medical team, and a patient support community;
a messaging module configured to read the updated medical data and send a message to at least one of the medical team and the patient support community if the updated medical data meets predetermined criteria.

2. The system of claim 1, wherein the message is a congratulatory message.

3. The system of claim 1, wherein the message is a warning message.

4. The system of claim 1, wherein the message is an informational message.

5. The system of claim 4, wherein the information message includes educational content.

6. The system of claim 1, further comprising a warning module configured to display a warning to the patient if the updated medical information is outside of an expected threshold.

7. The system of claim 1, wherein the message includes a reward certificate to redeem points that can be in the form of vouchers, coupons, cash, health care services, or other goods and services that are attractive to the patient and/or care team.

8. The system of claim 1, wherein the input field is configured based on at least one of a sign and a symptom identified by a physician associated with the patient.

9. The system of claim 1, wherein the predetermined criteria are set by at least one of a physician, nurse practitioner, physician assistant, or other qualified healthcare personnel associated with the patient.

10. The system of claim 1, further comprising an input interface configured to receive medical information about the patient, the medical information being one of a lab result, a test result, or an imaging result.

11. The system of claim 10, wherein the display interface is further configured to display the received medical information.

12. The system of claim 10, wherein the input interface is configured to receive information from a medical device.

13. The system of claim 11, wherein the display interface includes at least one of trends, graphs, and color coding schemes to display the received medical information.

14. The system of claim 1, wherein the input field is configured to received data from at least one of a wireless medical device or a wired medical device.

15. The system of claim 1, wherein the messaging module is configured to deliver messages via video, conference.
